(19) United States
(12) Patent Application Publication
(10) Pub. No.: US 2015/0317970 A1
(43) Pub. Date: Nov. 5, 2015

(54) BUZZER CIRCUIT

(71) Applicants: HONG FU JIN PRECISION INDUSTRY (wuHan) CO., LTD., Wuhan (CN); HON HAI PRECISION INDUSTRY CO., LTD., New Taipei (TW)

(72) Inventor: YONG-ZHAO HUANG, Wuhan (CN)

(21) Appl. No.: 14/573,445

(22) Filed: Dec. 17, 2014

(30) Foreign Application Priority Data
Apr. 30, 2014 (CN) 201410179575.4

(51) Int. Cl. G10K 9/12

(52) U.S. Cl. CPC G10K 9/12

(57) ABSTRACT

A buzzer circuit includes an amplifier U, a first electronic switch and a second electronic switch, a first resistor and a second resistor, and a buzzer. The buzzer circuit is coupled to a drive circuit for receiving a drive signal. The first electronic is turned on and when the power pin of the buzzer receives a high level drive signal, the second electronic switch is turned on, and the buzzer buzzes steadily.

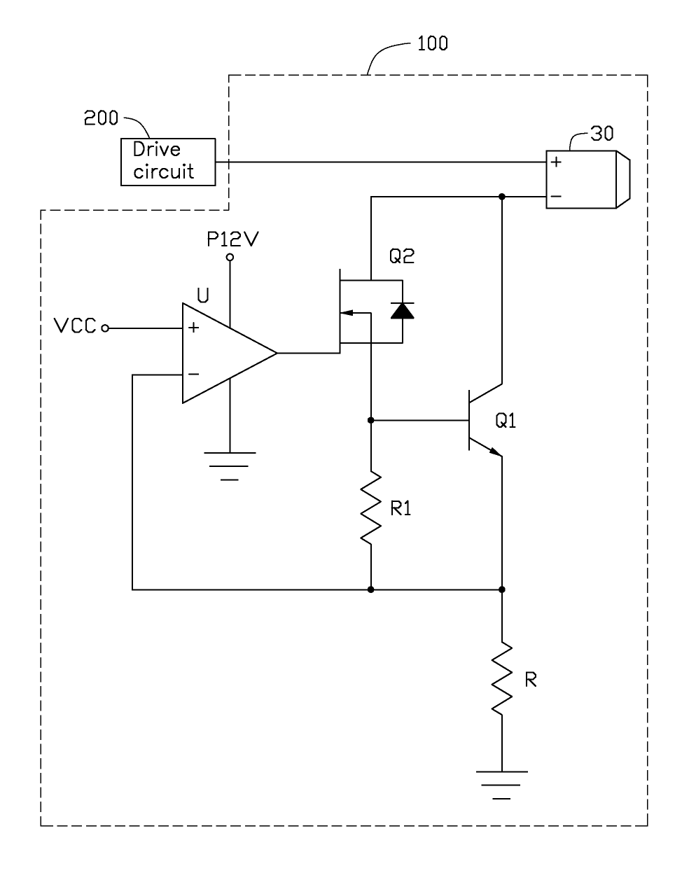

### FIELD

The subject matter herein generally relates to a buzzer circuit.

### BACKGROUND

A current of a traditional buzzer changes over time, which results in an unsteady sound from the buzzer.

### BRIEF DESCRIPTION OF THE DRAWINGS

Implementations of the present technology will now be described, by way of example only, with reference to the attached figure.

The figure is a circuit diagram of an embodiment of a buzzer circuit.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “comprising,” when utilized, means “including, but not necessarily limited to”; it specifically indicates open-ended inclusion or membership in the so-described combination, group, series and the like.

The present disclosure is described in relation to a buzzer circuit.

The figure illustrates an embodiment of the buzzer circuit 100. A drive circuit 200 is coupled to the buzzer circuit 100 for energizing the buzzer circuit 100. The buzzer circuit 100 can comprise an amplifier U, electronic switches Q1, Q2, resistors R, R1, and a buzzer 30.

The buzzer 30 can comprise a power pin VCC and a ground pin GND. The power pin VCC is coupled to the drive circuit 200 for receiving a drive signal.

A non-inverting input terminal of the amplifier U is coupled to a power supply VCC. An inverting input terminal of the amplifier U is coupled to ground through the resistor R. A power terminal of the amplifier U is coupled to a power supply P12V. A ground terminal of the amplifier U is coupled to ground. An output terminal of the amplifier U is coupled to a control terminal of the electronic switch Q2. A first terminal of the electronic switch Q2 is coupled to the ground pin GND of the buzzer 30. A second terminal of the electronic switch Q2 is coupled to ground through the resistor R1 and the resistor R in that order. A control terminal of the electronic switch Q1 is coupled to the second terminal of the electronic switch Q2. A first terminal of the electronic switch Q1 is coupled to the ground pin GND of the buzzer 30. A second terminal of the electronic switch Q1 is coupled to ground through the resistor R.

In at least one embodiment, a voltage of the inverting input terminal of the amplifier U is equal to a voltage V of the power supply VCC which is an input voltage of the non-inverting input terminal of the amplifier U. The power pin VCC of the buzzer 30 receives a high level drive signal when the drive circuit 200 outputs a high level signal. At the same time, the electronic switch Q1 is turned on. The ground pin GND of the buzzer 30 is coupled to ground through the first terminal and the second terminal of the electronic switch Q1 and the resistor R in that order. Wherein, r stands for a resistance of the resistor R, I stands for an operating current of the buzzer 30 and for a current flowing through the resistor R, and I is defined by the equation I=V/r. The voltage V is a constant value and the operating current I is constant. The buzzer 30 buzzes steadily.

In other embodiments, the operating current I of the buzzer 30 can be changed through changing the resistance of the resistor R or changing the voltage V of the power supply VCC.

In at least one embodiment, the amplifier U is utilized to amplify the voltage V to turn on the electronic switch Q2. In other embodiments, the amplifier U can be omitted when the voltage V is larger enough to turn on the electronic switch Q2. In that circumstance, the control terminal of the electronic switch Q2 is coupled to the power supply VCC, and the control terminal of the electronic switch Q2 is also coupled to ground through the resistor R.

In at least one embodiment, the electronic switch Q1 can be an NPN bipolar junction transistor, and the electronic switch Q2 can be an n-channel field effect transistor.

The embodiments shown and described above are only examples. Even though numerous characteristics and advantages of the present technology have been set forth in the foregoing description, together with details of the structure and function of the present disclosure, the disclosure is illustrative only, and changes may be made in the detail, especially in matters of shape, size and arrangement of the parts within the principles of the present disclosure up to, and including the full extent established by the broad general meaning of the terms used in the claims. It will therefore be appreciated that the embodiments described above may be modified within the scope of the claims.

What is claimed is:

1. A buzzer circuit coupled to a drive circuit, the buzzer circuit comprising:
a buzzer comprising a power pin and a ground pin, the power pin coupled to the drive circuit and configured to receive a drive signal from the drive circuit;
a first resistor, a second resistor;
a first electronic switch comprising a control terminal, a first terminal, and a second terminal, wherein the control terminal is coupled to a first power supply, the control terminal is coupled to ground through the first resistor, the first terminal is coupled to the ground pin of the buzzer, and the second terminal is coupled to ground through the second resistor and the first resistor in that order; wherein the first terminal is configured to connect to the second terminal, in response to the control terminal receiving a high level signal, and the first terminal is further configured to disconnect from the second terminal, in response to the control terminal receiving a low level signal; and
a second electronic switch comprising a control terminal, a first terminal, and a second terminal, wherein the control terminal is coupled to the second terminal of the first electronic switch, the first terminal is coupled to the ground pin of the buzzer, and the second terminal is coupled to ground through the first resistor; wherein the first terminal is configured to connect to the second terminal, in response to the control terminal receiving a high level signal, and the first terminal is further configured to disconnect from the second terminal, in response to the control terminal receiving a low level signal.

2. The buzzer circuit of claim 1, further comprising an amplifier, wherein a non-inverting input terminal of the amplifier is coupled to the first power supply, an inverting input terminal of the amplifier is coupled to ground through the first resistor, a power terminal of the amplifier is coupled to a second power supply, a ground terminal of the amplifier is coupled to ground, and an output terminal of the amplifier is coupled to the control terminal of the first electronic switch.

3. The buzzer circuit of claim 1, wherein the first electronic switch is an n-channel field effect transistor.

4. The buzzer circuit of claim 1, wherein the second electronic switch is an NPN bipolar junction transistor.
